(19) United States
(12) Patent Application Publication
(10) Pub. No.: US 2011/0121494 A1
(43) Pub. Date: May 26, 2011

(54) Method for the Production of an Electrically Insulating Cast Body and Base for a Lamp

(76) Inventor: Manfred Röhl, Bruckmuhl (DE)

(21) Appl. No.: 12/674,665

(22) PCT Filed: Aug. 31, 2007
(86) PCT No.: PCT/EP07/59087

§ 371 Date: Feb. 22, 2010

(51) Int. Cl. B29C 59/16; B29C 45/14; H01R 13/46

(52) U.S. Cl. 264/446; 264/267; 174/521

(57) ABSTRACT

A method for the production of an electrically insulating cast body having one or more electronic components that are arranged in a plastic casting chamber (214) that is filled with an electrically insulating casting compound, wherein the wall surfaces of a partial cavity (221) of the casting chamber are pretreated in such a way that the adhesion of the casting compound to the wall surfaces of the partial cavity (221) differs substantially from the adhesion of the casting compound to the wall surfaces of the remaining cavity (217).

### TECHNICAL FIELD

The invention relates to a method for the production of an electrically insulating cast body in at least one casting chamber, in particular in a holding space for electrical components of a discharge lamp, and to a base for a lamp, in particular for a high-pressure discharge lamp, having at least one holding space for electrical components of the lamp that are embedded at least in sections in an electrically insulating casting compound.

### PRIOR ART

The inventive method can be used principally for the production of electrically insulating cast bodies for different applications. The main field of application of the method could well, however, lie in the casting of holding spaces for electrical components in the base of a high-pressure discharge lamp.

Such a high-pressure discharge lamp is disclosed, for example, in EP 1 511 130 A1 of the applicant. In these conventional lamps, use is made of a base in which there is arranged an ignition transformer for generating the igniting voltage for the discharge lamp, in which there is arranged an electrical contact element that connects a voltage output of the ignition transformer to a power lead led out from the discharge vessel of the lamp on the base side. For the purpose of better electrical insulation, in this solution the contact element is partly embedded in the plastic base. The base has two chambers, a first end of the electrical contact element extending into the first chamber, and the second end of the contact element being accessible from the second chamber. The ignition transformer is arranged in the first chamber, and its igniting voltage output is connected to the first end of the contact element, while there are arranged in the second chamber further electronic components of the ignition device of the discharge lamp that place lesser demands on the voltage insulation than the ignition transformer. The second end of the contact element is accessible from the second chamber in order to be connected to the power lead led out of the discharge vessel near the base. To this end, the power lead of the lamp burner is introduced into a bore in the second end of the contact element and welded thereto. This enables a separate spatial arrangement of the ignition transformer conducting the high voltage. In order to improve the high voltage strength of the lamp base, the connecting point, lying in a holding space, between the second end of the contact element and the end of the power lead near the base, as well as the ignition transformer are embedded in an electrically insulating casting compound that is introduced into the chambers and forms an electrical insulation between the electrical components, in particular between the contact element and the primary winding of the ignition transformer.

A disadvantage with such cast bodies is that the high voltage strength frequently does not satisfy the high requirements placed on the insulation safety, since it is possible for material stresses to occur in the cast body upon curing of the casting compound because of shrinkage or through a change in temperature in the operation of the lamp, and thus for cracks to form in the cast body. The formation of cracks because of stresses inside the material is also denoted as a cohesive fracture. The electrical insulation is impaired along such cohesive fractures, and short circuits and flashovers between the electrical components can occur. Furthermore, it is disadvantageous that because of the complicated tuning of construction materials, casting geometry and casting compound such cast bodies are complicated and cost intensive to produce, since the changes in dimensions of the cast body have to be determined by calculations and/or pretests and correspondingly taken into account.

In order to circumvent such problems, methods that avoid an excessively large volume of the casting compound have been attempted. WO 2007/017202 A1 discloses a lamp base in the case of which the ignition transformer is not completely surrounded by the casting compound, the latter instead reaching only up to a third to half of the height of the ignition transformer. As a result, an excessively large volume of the casting compound is avoided, and so therefore are relatively large stresses within the latter. However, it is difficult to seal the ignition transformer such that it insulates the high voltage appropriately. To this extent, this method is disadvantageous as regards cost, since the ignition transformer becomes substantially more complicated and therefore more expensive.

### OBJECT

It is the object of the invention to provide a method for the production of an electrically insulating cast body, and a base for a lamp, in particular for a discharge lamp that enable an electrical insulation which is improved by comparison with conventional solutions in conjunction with a minimum outlay on apparatus.

This object is achieved by a method having the features of claim 1 and a base for a lamp, in particular for a high-pressure discharge lamp, having the features of claim 7.

### SUMMARY OF THE INVENTION

This method for the production of an electrically insulating cast body ensures that there are certainly no instances of detachment of the casting compound from the walls of the holding space, so-called adhesive fractures, and thus that the high voltage strength and breakdown strength of the arrangement are maintained. Owing to the targeted nontreatment of the other zones of the holding space, a detachment of the casting compound from the walls of the holding space is accepted, indeed even forced. Because of the fact that the casting compound contracts when shrinking, for example because of intense cooling of the lamp and therefore of the lamp base, a targeted detachment of the casting compound is achieved in noncritical regions, and the mechanical stress is therefore removed from the casting compound. Once the detachment has happened, the casting compound can expand and contract arbitrarily with each change in temperature without occurrence of stresses inside the casting compound. It is thus certainly possible to avoid cohesive fractures, that is to say the formation of stress-induced cracks inside the casting compound. Again, the detachment of the wall in the region critical in terms of high voltage is thus avoided, since the mechanical stresses in the critical region are also no longer present after detachments have occurred in the noncritical region.

It is advantageous to use a base plastic/casting compound system of substances that rather exhibits a poor adhesion of the casting compound on the base plastic in the case of an untreated base plastic.

It is preferred, furthermore, to use a base plastic/casting compound system of substances that exhibits a very good adhesion of the casting compound on the base plastic in the case of an untreated base plastic.

Any desired suitable methods such as primers or plasma treatments can be used for the pretreatment of the base plastic. The actual casting process preferably takes place in this case in vacuo.

For systems of substances that exhibit a good adhesion of the casting compound on the base plastic in the case of an untreated base plastic, it can also be advantageous to treat the cavities that are noncritical for the high voltage insulation in a suitable way in order to greatly reduce the adhesion of the casting compound on these partial cavities.

### BRIEF DESCRIPTION OF THE DRAWING(S)

FIG. 1 is a plan view from below of an inventive lamp base having a casting chamber 214 and a partial cavity 221 treated according to the inventive method.

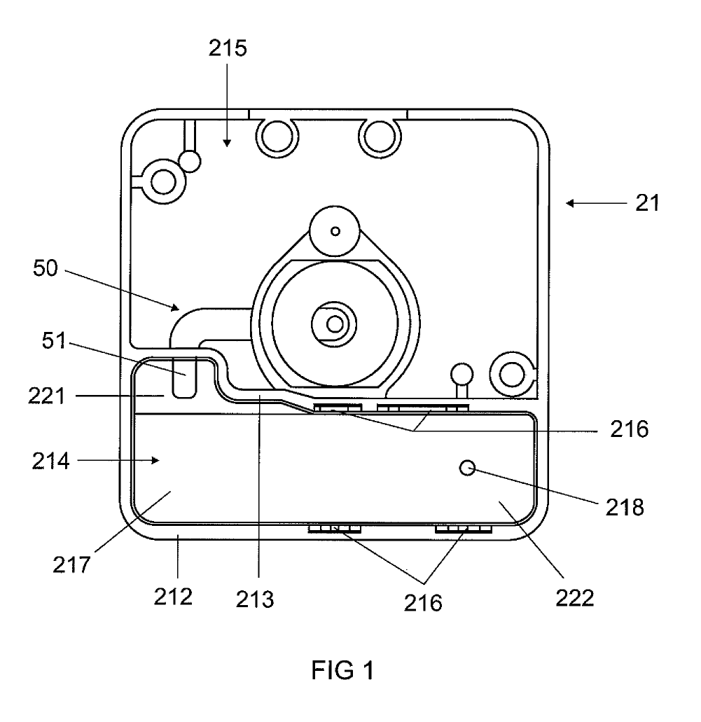

FIG. 2 is a perspective view of an inventive lamp base having a casting chamber 214 and a partial cavity 221 treated according to the inventive method.

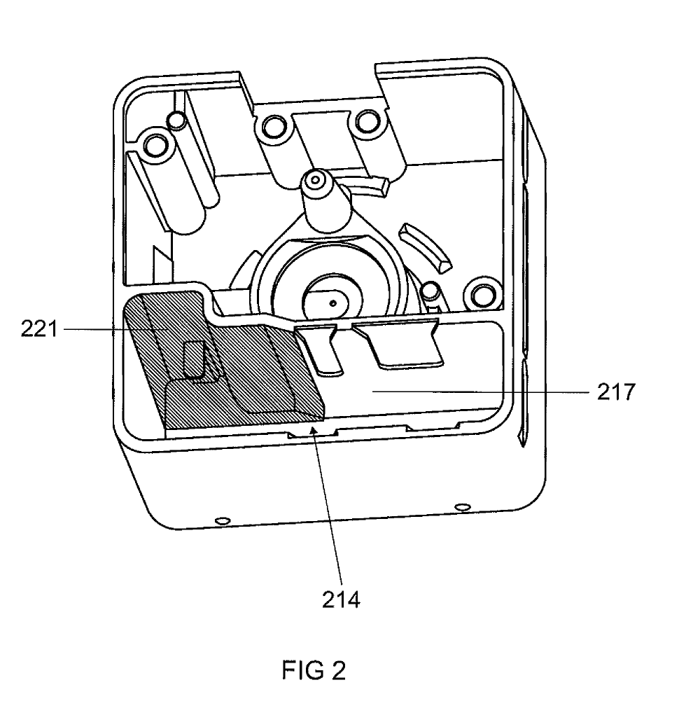

### PREFERRED DESIGN OF THE INVENTION

The preferred method for the production of an electrically insulating cast body is executed in a vacuum casting process known per se. Firstly, there is a system of substances that in the case of untreated surfaces of the base plastic exhibits a slight adhesion of the casting compound on the latter. The partial cavity 221 in the base part 21 is pretreated by a plasma treatment method in order to ensure a good adhesion of the casting compound in the pretreated region. The remaining wall surfaces of the cavity 214, that is to say the partial cavity 222, which is noncritical with reference to the high voltage strength, is not treated. After the treatment, the ignition transformer is inserted into the cavity and makes contact. The ignition transformer can likewise be treated at its surface correlated with the partial cavity 221 before being placed in the cavity. The cavity in the base part is then cast in a vacuum chamber. A two-component silicone casting compound is preferably used as casting compound. However, it is also possible to use any other suitable casting compound, for example a casting compound based on polyurethane or epoxy resin. This can be designed as a single-component casting compound or as a two-component casting compound. Owing to casting in vacuo, after aeration at normal pressure or overpressure the casting compound is also pressed into the ignition transformer in order to further improve the high voltage strength thereof. After the casting process, the casting compound inserted into the base parts is cured in a furnace. The parts are finished in principle thereafter, but, for the purpose of quality assurance they can further be subjected to a combined temperature cycling test and ignition test in order to ensure that the casting compound becomes detached at the predetermined points, that is to say on the partial cavity 222 on the wall of the cavity, while the wall adhesion in cavity 214 is completely maintained. Depending on the casting compound, however, this already takes place during the cooling phase after the curing, since the casting compound then contracts.

All suitable plastics can be applied as plastics material for the base, use preferably being made of plastics based on PEI (polyetherimide), PPS (polyphenylene sulfide) or LCP (Liquid Crystalline Polymers). These plastics have a high thermal stability and a high electrical breakdown strength, and therefore come into consideration as base plastics.

The combination of base plastic/casting compound preferred in the application is PEI/silicone.

Since the adhesion of the appropriate base plastics with the casting compounds used can be very different, other pretreatment methods are also conceivable apart from the preferred exemplary embodiment. In a plastic/casting compound system that has a good adhesion in the untreated state, the partial cavity that is noncritical with reference to the high voltage strength is preferably treated. In order to achieve the desired effect, the adhesion of the casting compound on the base plastic in the treated region should be significantly poorer after the treatment. The treatment can be effected again by suitable chemical or physical methods. Known release agents such as, for example, wax emulsions or the like can be used in order to degrade the wall adhesion of the casting compound.

1. A method for the production of an electrically insulating cast body having one or more electronic components that are arranged in a plastic casting chamber that is filled with an electrically insulating casting compound, wherein the wall surfaces of a partial cavity of the casting chamber are pretreated in such a way that the adhesion of the casting compound to the wall surfaces of the partial cavity differs substantially from the adhesion of the casting compound to the wall surfaces of the remaining cavity.

2. The method for the production of an electrically insulating cast body as claimed in claim 1, comprising using the casting chamber of a casting compound/plastic system of substances that have a very good mutual adhesion in the untreated state.

3. The method for the production of an electrically insulating cast body as claimed in claim 1, comprising using the casting chamber of a casting compound/plastic system of substances that have a poor mutual adhesion in the untreated state.

4. The method for the production of an electrically insulating cast body as claimed in claim 1, wherein a primer method serves for pretreating the partial cavity.

5. The method for the production of an electrically insulating cast body as claimed in claim 1, wherein a plasma treatment method is used for pretreating the partial cavity.

6. The method for the production of an electrically insulating cast body as claimed in claim 1, wherein the actual casting process takes place in vacuo.

7. A base for a lamp having at least one holding space for electrical components of the lamp that are embedded at least in sections in an electrically insulating casting compound, wherein the wall surfaces of a partial cavity of the casting chamber are pretreated in such a way that the adhesion of the casting compound to the wall surfaces of the partial cavity differs substantially from the adhesion of the casting compound to the wall surfaces of the remaining cavity.

8. The base for a lamp as claimed in claim 7, wherein the casting chamber includes a casting compound/plastic system of substances that have a very good mutual adhesion in the untreated state.

9. The base for a lamp as claimed in claim 7, wherein the casting chamber includes a casting compound/plastic system of substances that have a poor mutual adhesion in the untreated state.

10. (canceled)

11. The base for a lamp as claimed in claim 7, wherein a primer method serves for pretreating the partial cavity.

12. The base for a lamp as claimed in claim 7, wherein a plasma treatment method is used for the pretreatment.

13. The base for a lamp as claimed in claim 7, wherein the actual casting process takes place in vacuo.
